(19) United States
(12) Patent Application Publication
(10) Pub. No.: US 2023/0345521 A1
(43) Pub. Date: Oct. 26, 2023

(54) Reserve Radio Resources for Planned Actions

(71) Applicant: Telefonaktiebolaget LM Ericsson (publ), Stockholm (SE)

(72) Inventors: Géza Szabó, KECSKEMÉT (HU); Sándor Rácz, CEGLÉD (HU); Norbert Reider, TÉNYÖ (HU); Anna Larmo, ESPOO (FI)

(21) Appl. No.: 18/008,477

(22) PCT Filed: Jun. 18, 2020
(86) PCT No.: PCT/EP2020/066954

§ 371 Date: Dec. 6, 2022

(51) Int. Cl. H04W 72/566; H04W 72/04; H04W 72/543

(52) U.S. Cl. CPC H04W 72/566; H04W 72/04; H04W 72/543

(57) ABSTRACT

A method is provided for operating a resource reservation entity configured to reserve radio resources in a cellular network for user entities connected to the cellular network, the user entities comprising a first user entity connected to a robotic device, and a second user entity not connected to any robotic device, the method including:
receiving a first message indicating future resource needs as needed by the first user entity to control a first task to be carried out by the robotic,
reserving the radio resources for the user entities, wherein in the reserving, a priority assigned to the first user entity is increased for duration of a first time period relative to the priority assigned to the second user entity, and the priority assigned to the first user entity in the first time period is higher than the priority assigned to the second user entity.

### TECHNICAL FIELD

The present application relates to a method for operating a resource reservation entity configured to reserve radio resources in a cellular network for a plurality of user entities. Furthermore, the corresponding resource reservation entity is provided, a computer program comprising program code and a carrier comprising the computer program.

### BACKGROUND

In the past few years, there has been an increasing demand from customers towards the manufacturing industry to provide more and more customized products. Personalized production is one of the key motivations for manufacturers to start leveraging new technologies that enable to increase, for instance, the flexibility of production lines. High flexibility in general is needed to realize cost effective and customized production by supporting fast reconfiguration of production lines, as well as easy application development.

Use cases of 5G URLLC (Ultra Reliable and low latency Communication) include autonomous vehicles that perform cooperation and safety functions, monitoring and control in smart grids, tactile feedback in remote medical procedures, control and coordination of unmanned aviation vehicles, robotics, and industrial automation.

One of the most challenging applications in which the importance and capabilities of URLLC can be demonstrated is the low-level remote control of servos. Industrial applications such as robot arms and robot cell control require a massive collaboration of the controlled servos making the use case even more challenging. Among the many industrial use cases such as cell automation, automated guided vehicles, etc. where wireless communication can play a significant role, particular emphasis is placed on the remote robot control in this application.

In wireless transport there are always resource limitations e.g., wireless spectrum and reasonable resource allocation are always valid issues to tackle. It is an issue how to best make use of the scarce radio resource when multiple industrial devices (e.g., robot arms) are connected over wireless networks. It is questionable how to take into account different radio resources in the planning phase of the system and reserve them in the execution phase.

5G Systems (3GPP TS23.501) support Time Sensitive Communications (TSC) and allow the 5G System to be integrated transparently as a bridge in an IEEE TSN (Time Sensitive Networking) network. The TSC assistance information describes TSC traffic characteristics to be used in the 5G System. The knowledge of TSN traffic pattern is useful for the gNB to allow more efficient scheduling of periodic, deterministic traffic flows either via Configured Grants, Semi-Persistent Scheduling or with dynamic grants.

A need exists to further improve the controlling of robotic devices over a cellular network.

### SUMMARY

This need is met by the features of the independent claims. Further aspects are described in the dependent claims.

According to a first aspect, a method for operating a resource reservation entity is provided which is configured to reserve radio resources in a cellular network for a plurality of user entities connected to the cellular network. The plurality of user entities comprise at least one first user entity connected to a robotic device which is controlled by control commands transmitted through the cellular network to the first user entity, wherein the user entities furthermore comprise a second user entity not connected to any robotic device. The resource reservation entity receives a first message including future resource needs as needed by the at least one first user entity to control at least one first task to be carried out by the robotic device based on the control commands, wherein the resource needs include a first time period defined by a defined starting time of the at least one first task and a duration of the at least one first task. The resource reservation entity then reserves the radio resources for the plurality of user entities, wherein in this reservation step, a priority assigned to the at least one first user entity is increased for the duration of the first time period relative to the priority assigned to the at least one second user entity. Furthermore, the priority assigned to the at least one first user entity in the first time period is higher than the priority assigned to the at least one second user entity.

Furthermore, the corresponding resource reservation entity is provided comprising a memory and at least one processing unit, wherein the memory contains instructions executable by the at least one processing unit. The resource reservation entity is operative to work as discussed above or as discussed in further detail below when the instructions are executed by the at least one processing unit.

As an alternative a resource reservation entity is provided configured to reserve radio resources in the cellular network for the plurality of user entities connected to the cellular network, wherein the plurality of user entities comprise at least one first user entity connected to a robotic device which is controlled by control commands transmitted through the cellular network to the first user entity. The plurality of user entities furthermore comprise at least one second user entity not connected to any robotic device. The resource reservation entity comprises a first module configured to receive a first message indicating future resource needs as needed by the at least one first user entity to control at least one first task to be carried out by the robotic device based on the control commands. The first message and the resource needs include a first time period defined by a defined starting time of the at least one first task and by a duration of the at least one first task. The resource reservation entity comprises a second module configured to reserve the radio resources for the plurality of user entities, wherein in the reserving, a priority assigned to the at least one first user entity is increased for the duration of the time period relative to the priority assigned to the at least one second user entity, and the priority assigned to the at least one first user entity in the first time period is higher than the priority assigned to the at least one second user entity.

The present application helps to improve the reservation process in the resource reservation entity as the future resource needs include not only the defined starting time of the controlling of the robotic device but also the duration. Accordingly, the resource reservation entity can carry out a preallocation in advance in time. Preferably, the received first message indicating the future resource needs is received from a control entity controlling the robotic device so that the control entity or control application can directly initiate and communicate the reservation needs.

Furthermore, a computer program comprising program code is provided wherein execution of the program code causes the at least one processing unit of the resource reservation entity to execute a method as discussed above or as explained in further detail below. Additionally, a carrier comprising the computer program is provided, wherein the carrier is one of an electronic signal, optical signal, radio signal, or computer readable storage medium.

It is to be understood that the features mentioned above and yet to be explained below can be used not only in the respective combinations indicated, but also in other combinations or in isolation without departing from the scope of the present application. Features of the above-mentioned aspects and embodiments described below may be combined with each other in other embodiments unless explicitly mentioned otherwise.

### BRIEF DESCRIPTION OF THE DRAWINGS

The foregoing and additional features and effects of the application will become apparent from the following detailed description when read in conjunction with the accompanying drawings in which like reference numerals refer to like elements.

FIG. 1 shows an architectural view of a system in which radio resources are reserved for the controlling of a robotic device.

FIG. 2 shows a more detailed view of a planning part of the system shown in FIG. 1.

FIG. 3 shows a schematic view of the radio resource reservation based on a weight based scheduling.

FIG. 4 shows a schematic view of a message exchange between the involved entities for the successful reservation and allocation of radio resources in the system shown in FIG. 1.

FIG. 5 shows a schematic view of a message exchange between the involved entities for the reservation and allocation of radio resources in a system shown in FIG. 1 where the reservation process was not successful.

FIG. 6 shows an example schematic flowchart of a method carried out by the resource reservation entity in the process of the resource reservation.

FIG. 7 shows an example schematic representation of the resource reservation entity configured to reserve radio resources for the controlling of a robotic device.

FIG. 8 shows another example schematic representation of the resource reservation entity configured to reserve radio resources for the controlling of the robotic device.

### DETAILED DESCRIPTION OF DRAWINGS

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are to be illustrative only.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter may also be implemented by an indirect connection or coupling. A coupling between components may be established over a wired or wireless connection. Functional blocks may be implemented in hardware, software, firmware, or a combination thereof.

Within the context of the present application, the term user entity, mobile entity or user equipment, UE, refers to a device for instance used by a person such as the user for his/her personal communication. It can be a telephone type of device, for example a telephone or a session initiation protocol, SIP, or voice over IP phone, cellular telephone, mobile station, cordless phone, or a personal digital assistant type of device like laptop, notebook, notepad, tablet equipped with a wireless data connection. In the presence context, the UE is associated with a non-human, the robotic device. The UE may be equipped with a SIM, subscriber identity module, comprising unique identities such as the IMSI, international mobile subscriber identity, TMSI, temporary mobile subscriber identity, or GUTI, globally unique temporary UE identity, associated with the user being the UE. The presence of the SIM within the UE customizes the UE uniquely with a subscription of the user.

It is to be noted that there is a difference but also tight connection between a user and a subscriber. The user gets access to the cellular network by acquiring a subscription to the network and by that becomes a subscriber within the network. The network then recognizes the subscriber and uses the associated subscription to identify related subscription data. The user can be the actual user of the UE, and the UE may also be the one owing the subscription but the user and the owner of the subscription may also be different.

In the following, a solution is discussed how to indicate radio resource needs of an application controlling a robotic device to a wireless network during the execution of a certain task to be carried out by the robotic device. A radio resource reservation method is discussed based on a weight based scheduling. A robotic device operating in a cellular network can be controlled over a wireless link while the required network characteristics are relaxed, whereas the productivity key performance indicators, KPIs, are still maintained. The proposed mechanism is also based on the fact that in many operation phases of the robotic device, the requirements can be softened, since it does not have impact on the quality or the performance of the robotic device.

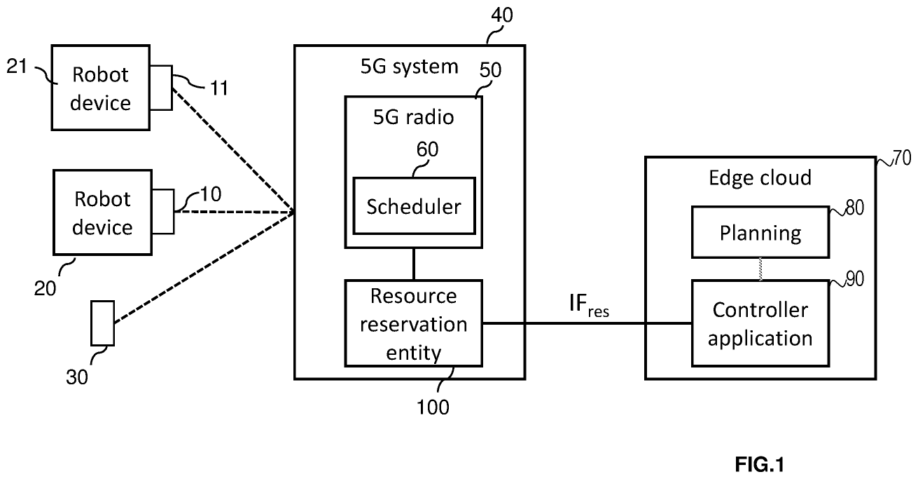

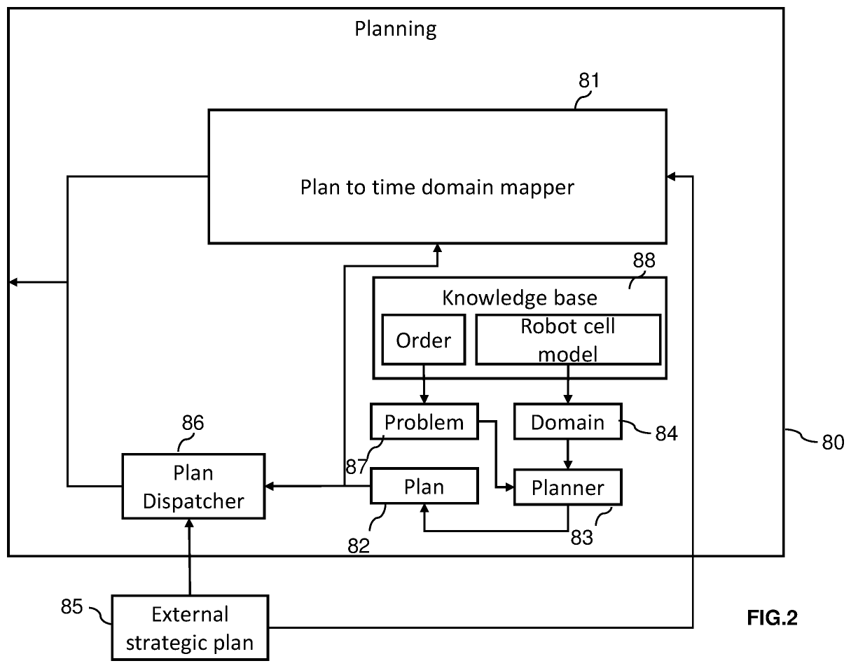

FIG. 1 shows an architectural view of a system in which robotic devices such as the devices 20 and 21 are controlled by a control application 90 using a cellular network 40. A planning module 80 processes the problem and domain definitions to produce a plan as will be discussed in further detail in connection with FIG. 2. The application 90 uses the plan provided by the planning module 80 to execute the actions of the robotic device, wherein each robotic device is connected to the cellular network using UEs 10 or 11. Furthermore, a UE 30 is schematically shown which is not connected to a robotic device but which also needs the radio resources of the cellular network for communication. The control application 19 communicates some details of the plan, such as the starting time and the duration of the action over the proposed interface IFᵣₑₛ in order to indicate information what resource needs the action of the robotic device to carry out a certain task may require from the cellular system which in the implementation shown is implemented as a 5G system. Accordingly, the cellular system can also be optimized to use only the necessary resources when meeting the needs of the applications while the performance of the robotic devices is not affected.

The planning module 80 and the control application 90 may be provided in the edge cloud 70. However, a location outside a cloud is also possible. The cellular network 40 comprises a resource reservation entity 100 which is receiving the information from the control application and which is configured to reserve the radio resources of the cellular network. The radio resource entity 100 is connected to a radio part 50 of the cellular network 40 where a scheduler 60 is located which finally schedules the radio resources using the input from the resource reservation entity 100. It is also possible that the resource reservation entity 100 and the scheduler 60 are implemented in a single module.

FIG. 2 shows a more detailed view of the planning module 80. During planning the order for the robotic device is transformed into a problem definition, the order and the robotic cell model are provided in a knowledge base 88 and the order is provided to a problem 87 which forwards the information to planner 83. The planner 83 processes the problem and domain definitions given by domain 84 and comes up with a plan 82 which is provided to the plan dispatcher 86 and the plan to time domain mapper 81. Furthermore, information from an external strategic plan 85 may be used. The output of the planning includes information on the radio resource needs for each action which will then be provided to the cellular network to optimize allocation of its resources to fulfill the request. The planner creates solution proposals which are executed in the plan dispatcher 86.

The example below shows an output of a planner 83:
107.0083: (UR_PICK_PRECISE UR YELLOWBOX2 YELLOWBOX1 GEAR6) [3.0000]
110.0085: (UR_PLACE_PRECISE UR YELLOWBOX2 SHIPPINGBOX2 GEAR6) [4.5000]
114.5090: (UR_MOVE UR YELLOWBOX2 YELLOWBOX4) [5.0000]
119.5093: (UR_PICK_PRECISE UR YELLOWBOX4 YELLOWBOX5 DISK10) [3.0000]
122.5098: (UR_MOVE UR YELLOWBOX4 YELLOWBOX2) [5.0000]
127.5100: (UR_PLACE_PRECISE UR YELLOWBOX2 SHIPPINGBOX2 DISK10) [4.5000]
132.0103: (HEBI_MOVE UR HEBI_DOF_SIX2 YELLOWBOX2 YELLOWBOX4) [5.0000]
137.0105: (UR_PICK_PRECISE UR YELLOWBOX4 YELLOWBOX5 DISK9) [3.0000]
140.0110: (UR_MOVE UR YELLOWBOX4 YELLOWBOX2) [5.0000]
145.0113: (UR_PLACE_PRECISE UR YELLOWBOX2 SHIPPINGBOX2 DISK9) [4.5000]
149.5117: (UR_MOVE UR YELLOWBOX2 YELLOWBOX5) [10.0000]

Accordingly, each row shown above comprises the following fields:
a starting time of the action in the seconds, the action itself, and the duration of the action.

In case of a realistic modeling of the actions in the domain definition, the provided plan represents the real life quite well. The radio network should reserve the necessary resources at a given time for a given duration of a specific action of the robotic device which is connected to the cellular network via a particular UE.

In the following, the indication of the radio resource needs is discussed in more detail.

In the following, it is disclosed how to take into account the radio resource requests of the application in the cellular network by providing the above-mentioned information via the interface IFᵣₑₛ. This embodiment allows a fine-grained handling of the necessary resources on a level of the transmission time intervals, TT's, of the packet scheduler of the radio part of the network. The provided information of the action carried out by the robotic device can then be translated into a resource reservation time in the packet scheduler of the radio network. The scheduler 60 shown in FIG. 1 is responsible for allocating the radio resources among different UEs and data flows. This could be implemented as an extension of the semi-persistent scheduling and configured grant procedures that have been specified for the mobile devices, but with shorter time scale.

Using this interface IFᵣₑₛ the controller application can communicate with the scheduler via the resource reservation entity and the application may also receive notification on a lack of transmit power, meaning a lack of possible radio resources. The controller application 90 can inform the resource reservation entity 100 about the estimated execution time until when the radio resources need to be reserved, by way of example, the duration of the robotic action. The application furthermore provides a UE identifier that generates the traffic to be prioritized, the delay limits the packets can tolerate during the reserved time period. Furthermore, the application can provide a traffic pattern generated during the reservation period.

The resource reservation entity can inform the application 90 of a notification on lack of transmit power.

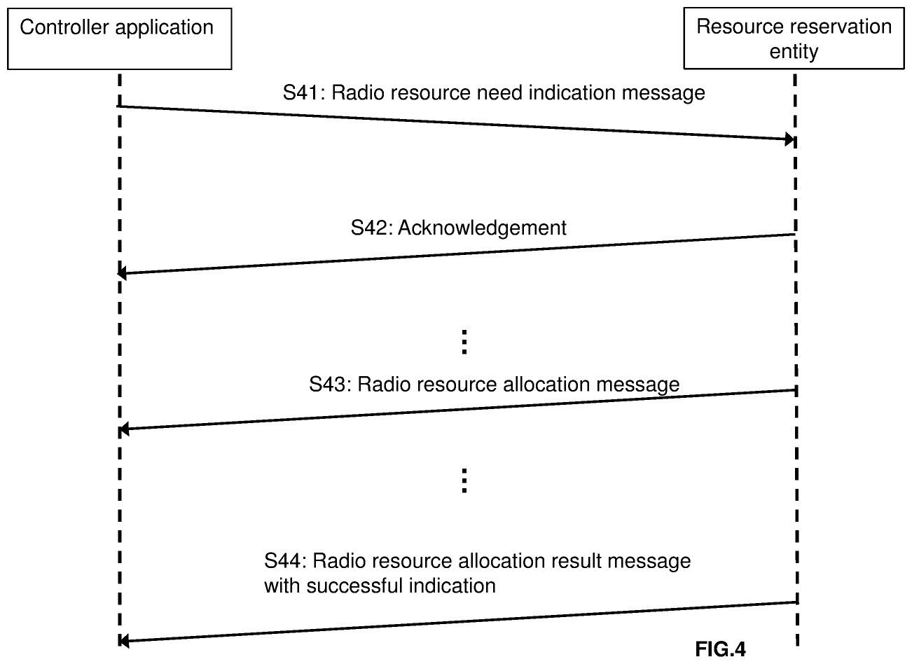

FIG. 4 shows a possible message exchange between the control application 90 and the resource reservation entity 100. In step S41, a message is transmitted from the application to the resource reservation. This message can be a radio resource need indication message and can comprise the following information elements:
the time of allocation
the duration of the robot action
the UE ID to do the allocation for
the preferred delay budget for the packets
and the traffic pattern of the controller.

The traffic pattern can include information about the moments with traffic and without traffic within the time period and/or can comprise information about different priorities within a time period. In step S42, an acknowledgment is transmitted back to the controller application 90.

Later in time, when the scheduling of the UE is about to start, the resource reservation entity transmits in step S43 a radio resource allocation message with the information element of the UE ID. Further, later on, when the scheduling of the UE is done for the reservation time period, an allocation message including the result of the allocated radio resources is transmitted in step S44 to the controller application including the information elements of the UE ID, the result that the allocation was successful and the reason that the reservation period has ended.

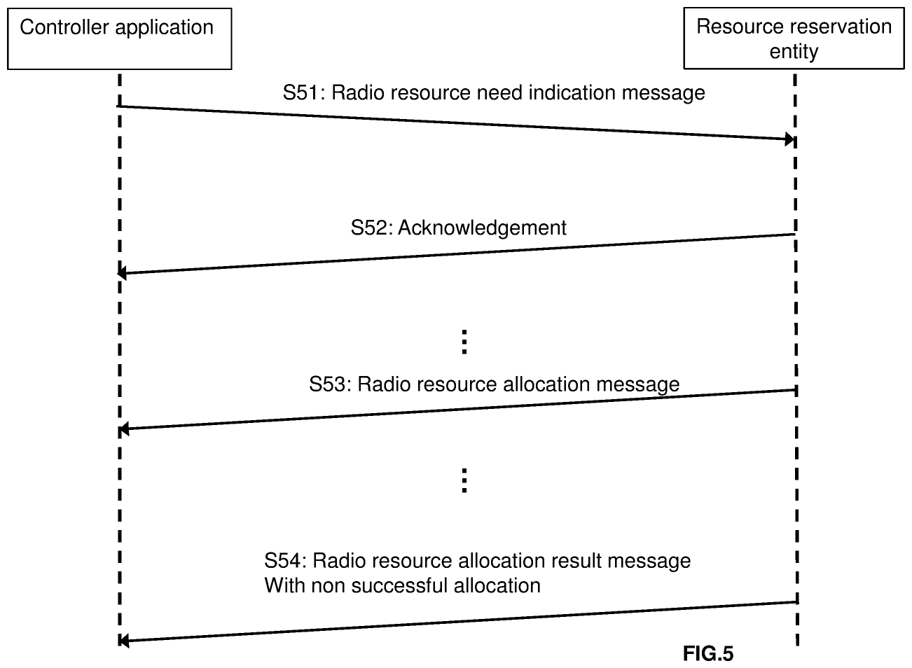

FIG. 5 shows the message exchange between the involved entities with an allocation process for a transmit power limited UE, meaning a depleted UE transmit power as not enough radio resources are available.

In step S51, a radio resource need indication message is transmitted to the reservation entity 100, wherein the message corresponds to the message transmitted in FIG. 4 in step S41 so that the information elements contained in this message are the same as for step S41. In step S52, an acknowledgment is sent back to the controller application, however, the acknowledgment can also be a negative acknowledgment with a reason. Later on, when the scheduling of the UE is about to start, the radio resource allocation message similar to the message of step S43 is transmitted in step S53 also including the UE ID. Then the scheduling of the UE is ongoing and the transmit power is depleted, a message is transmitted in step S54 to the controller application that the allocation was not successful. The message furthermore includes the UE ID and the reason that it is out of transmit power.

In the example shown, the controller application is the controller of the robotic device while the radio resource reservation is carried out in the resource reservation entity. The radio resource reservation could also be implemented in the packet scheduler directly. Accordingly, with reference to FIG. 1 the scheduler 60 and the resource reservation entity 100 could be implemented in a single functional entity.

The proposed reservation process could be implemented as follows:
first, a timer Tᵣₑₛ is introduced and set to the estimated duration of the action and the timer is sent via the interface IFᵣₑₛ. Then in each TTI until the timer expires the data of the identified user context are prioritized.

The resource blocks are limited in each TTI, so it has to be made sure that the right scheduling order of the user contexts or user data are maintained. As shown in FIG. 1, there are normal UEs, such as UE 30, which are not connected to a robotic device, for which no reservation is provided, whereas at the same time multiple UEs such as UEs 10, 11 may be provided for which radio resources need to be reserved.

Accordingly, it is possible to use a weight based scheduling scheme that can adjust the reservation of the radio resources on the level of the TTI, or even on the level of the resource blocks, RB, to minimize unutilized radio resources.

To decide which of the UEs 10, 11 or 30 should be scheduled, basically three factors may be considered, namely first of all the quality of the service requirements of the UE. The quality of service requirements reflect the different priorities which are needed by the different UEs to transmit data. Furthermore, the channel quality can be considered, wherein the channel quality describes the quality of the radio connectivity obtained for the channel between the UE and the corresponding radio access node. A third factor can be the UE's interference impact on each other. This interference takes into account how far the different UEs are located physically one from the other. The weight based scheduling scheme can select the UEs according to a weight function which includes components of all the above three factors. However, it is also possible to use only two or one of the above factors such as the quality or service requirement alone.

The first component of the weight function such as the quality of service, QoS weight, is calculated per UE and expresses how urgent the transmission of the packets is. Normally, the QoS weight function can make sure that a fair distribution is obtained as a UE will get an increasing weight as the time spent in a transmit buffer increases.

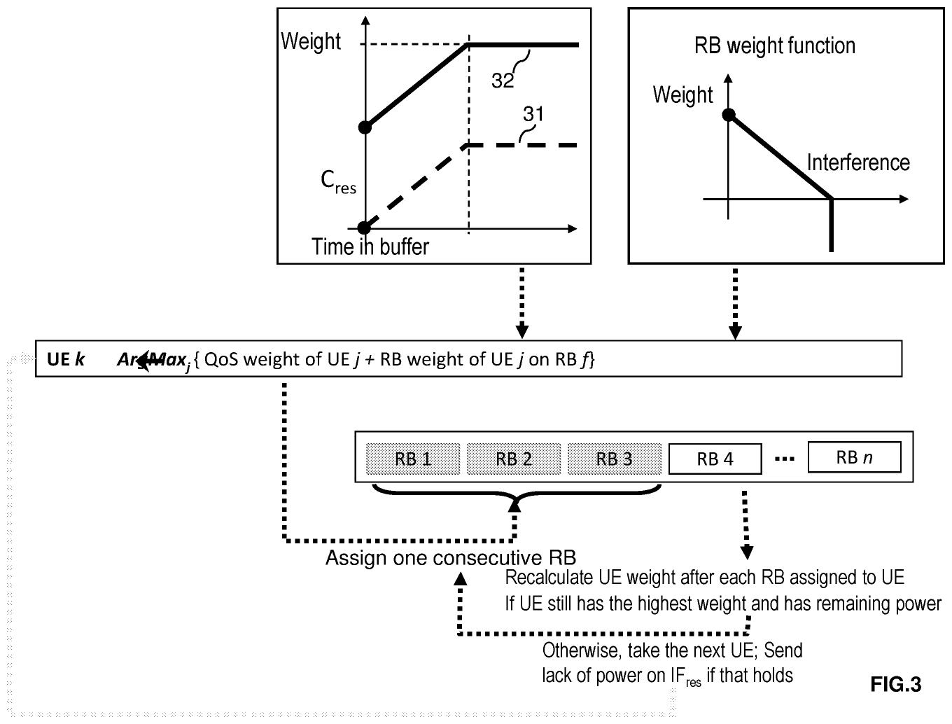

It is proposed, as shown in FIG. 3, to add a constant Cᵣₑₛ to the quality of service weight function until the timer Tᵣₑₛ expires. As shown in the upper left side of FIG. 3, by curve 31 the weight of the quality of service requirement increases with time. With the increasing time, the corresponding data packet is located in the corresponding transmit buffer. The graph 32 then shows the corresponding weight function in dependence on time for a time period in which the corresponding UE has scheduled a transmission of control commands to control the robotic device. As shown in FIG. 3, curve 32 or the weight is increased by a constant factor Cᵣₑₛ compared to a UE for which no control commands are transmitted through the network. In the right part of FIG. 3, it is shown that the corresponding weight function decreases when the interference increases.

This method ensures that the priority is increased for UEs that need reserved radio resources. When the timer expired, the corresponding UE is again handled as a normal UE and the scheduling is not prioritized anymore since the action in the robotic cell is finished.

The value of Cᵣₑₛ should be higher than the maximum weight of the other UEs, which are not connected to robotic devices. Among their prioritized UEs, the UE with a stricter delay limit might have a higher value Cᵣₑₛ as the other UEs. If traffic patterns are also available, by way of example, they were signaled by their application, then the optimal values of the constant factor Cᵣₑₛ could be calculated in advance. The radio resource reservation can be implemented as an optimization problem, where in the embodiment shown in FIG. 3 one part of the optimization problem includes the quality of service weight of the UE, wherein the other part jointly considers the other two factors such as the UE's channel quality and the interference impact. Accordingly, in the embodiment shown, the resource block weight considers these two components. The optimization process for these components is known per se, in the present invention only the QoS weight is amended compared to the known method, by way of example, by using a higher priority in the time period where the robotic device needs to be controlled with control commands transmitted over the wireless part of the cellular network. The resource block weight can express the loss in terms of number of bits suffered by already scheduled UEs on the same resource block in another cell. The detailed description of the resource block weight function is omitted as it is known to a person skilled in the art. As shown in FIG. 3, it is an iterative process in which the resource blocks are consecutively assigned to a UE or the different UEs. The UE weight is then recalculated after each resource block is assigned to a UE if the UE still has the highest weight and has a remaining power. Otherwise the next UE is taken and possibly the lack of power or the lack of transmit resources is transmitted via the interface if that holds.

The advantage of the above-discussed solution is that the radio resource allocation can be adjusted on resource block level. This means that as much radio resources are used as really needed for each UE, in contrast to a dedicated allocation. Furthermore, the weight based scheduling ensures that in case multiple UEs need reserved radio resources, then the channel quality, fairness and interference calculations are still taking into account in the scheduling order and in the final resource allocations.

The different actions carried out by the robotic device can require different radio resources to be reserved or at least a radio resource need estimate should be possible to be conveyed to the resource reservation entity. This request for resource needs should be considered during the radio resource reservation process.

In addition to making a request for a resource reservation, the requesting entity may be provided with feedback on the success of the request. This can in turn help the requesting entity to adjust timings of high accuracy actions to be in line with the radio resource availability.

The reserved radio resource may not be enough to serve the task to be carried out by the robotic device accurately. A PID (Proportional-Integral-Derivative) error of the controller can be fed into the radio resource reservation process to reserve more resources in case the targeted accuracy is not reached. The plan could be implemented and processed on the fly and fed into the system. Furthermore, it is possible to use a ladder logic which is commonly used to control robotic devices with PLCs, programmable logic controllers. The PLCs can have a strict execution time which can be calculated and represented via timing diagrams. The timing is a similar input to the executable plans in the previous sections discussed above.

Furthermore, it is possible to switch between different channels providing the necessary quality of service requirements. It enables differentiated data services to support diverse application requirements while using radio resources efficiently. It is designed to support different access networks where the quality of service without extra signaling may be desirable. Standardized packet marking schemes can inform the quality of service enforcement functions what quality of service to provide without any QoS signaling.

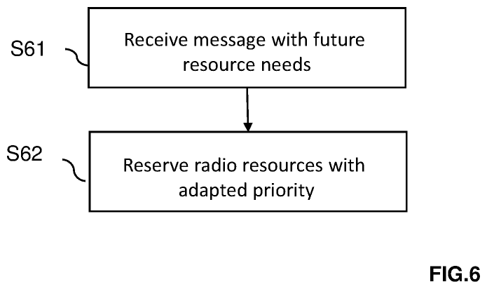

FIG. 6 summarizes some of the steps carried out by the resource reservation entity 100 in the implementation discussed above. In one step S61, the radio resource reservation entity receives a message indicating the future resource needs, wherein these resource needs include a time period defined by a starting time of a task to be carried out by a robotic device, wherein the resource needs furthermore include the duration of the task. The task can be a single task or can be a sequence of tasks wherein each task is defined by a corresponding starting time and a corresponding time period how long the task will take. In step S62, the radio resources are reserved for several UEs, wherein the priority for the UEs which are connected to a robotic device is increased so that due to the higher priority, the scheduling of the UEs with a connected robotic device will be prioritized compared to the other UEs which are not connected to a robotic device. When the time period for the task to be carried out by the robotic device is over, the increase of the priority is removed again. After the time period, the UEs's 10, 11 of FIG. 1 can have the same priority as the UES 30 which are not commended to a robotic device.

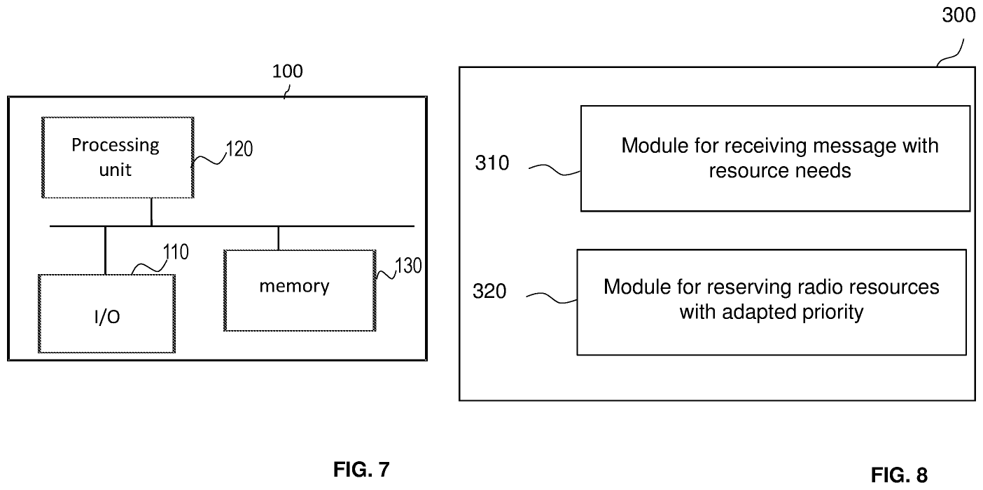

FIG. 7 shows a schematic architectural view of the resource reservation entity which can carry out the above-discussed resource reservation. The resource reservation entity 100 comprises an interface 110 which is provided for transmitting user data or control messages to other entities and which is provided for receiving user data and control messages from other entities. The interface is configured to receive the message indicating the future resource needs and the interface can be used to forward the determined reservation to the scheduler of the cellular system if the scheduler and resource reservation entity are implemented in different nodes. The entity 100 furthermore comprises a processing unit 120 which is responsible for the operation of the resource reservation entity. The processing unit 120 can comprise one or more processors and can carry out instructions stored on a memory 130, wherein the memory may include a read-only memory, a random access memory, a mass storage, a hard disk or the like. The memory can furthermore include suitable program code to be executed by the processing unit 120 so as to implement the above-described functionalities, in which the resource reservation entity is involved.

FIG. 8 shows another schematic view of a resource other entities 300 which comprises a first module 310 configured to receive the first message with the future resource needs that are needed to control a task to be carried out by the robotic device. The message comprises the duration of the task and a starting time. A module 320 is provided configured to reserve the radio resources with a priority adaptation for the UEs during the time period in which the task is to be carried out.

From the above-said some general conclusions can be drawn for the resource reservation entity.

When the priority has been increased for the time period of the task, the priority assigned to the at least one first user entity, which is connected to the robotic device is decreased again relative to the priority assigned to the other UE such as UE 30 which is not connected to the robotic device when the time period is over.

The user entity which is connected to the robotic device may be specified as first user entity wherein the other user entity not connected to the robotic device may be specified as second user entity.

The future resource needs which are received in the message may include a traffic pattern for the radio resources during the first time period, wherein the radio resources are reserved during this first time period taking into account the received traffic pattern.

It is possible to activate a timer at the defined starting time of the first time period which expires when the first time period is over. The priority assigned to the at least one first user entity is controlled based on the activation of the timer. Accordingly as long as the timer is running, the priority assigned to the first user entity is higher than the priority for the second user entity.

The reservation of the radio resources can comprise using a weight based reserving in which a plurality of factors are weighted in order to reserve the radio resources for the plurality of user entities. The factors can comprise a first factor relating to the quality of service requirements valid for the user entities wherein the quality of service requirements depend on the priority assigned to the corresponding user entity, wherein a second factor describes a quality of the obtained radio channel and a third factor describes an interference level between at least some of the user entities.

For increasing the priority of the first factor in the first time period a weight assigned to the first factor can be increased by a first value for the first time period.

This first value can be a constant value and the increase of the weight assigned to the first value can be removed again when the first time period is over. The resource needs can furthermore include a possible maximum delay for the control commands until when the control commands have to be arrived at the user entity wherein the radio resources are reserved taking into account the possible maximum delay.

Furthermore, it is possible to transmit a scheduling message to the first user entity when the first time period is about to start, wherein this scheduling message comprises a UE identifier allowing the at least one first user entity to be identified.

The future resource needs received in the first message can also relate to different tasks carried out by one of the user entities in a sequence of tasks. Furthermore, different time periods are defined for the different tasks and the priority assigned to the corresponding user entity is increased in each of the different time periods relative to the priority of the second user entity.

In this context, it is possible that the priority assigned to each of the different time periods is not the same for all of the different time periods. Furthermore, it is possible to inform a device control entity configured to control the robotic device when it is determined that the reserving of the radio resources is not possible in the desired time period as requested by the future resource needs.

The task to be carried out by the robotic device can also be a repeated task carried out several times. It is possible that a feedback is received with an accuracy indication indicating a failed accuracy when the corresponding task is carried out a first time of the several times. This accuracy indication is then taking into account when reserving the radio resources for the first task when it is carried out a second time after the first time. The priority assigned to the first time period when the first task is carried out a second time is higher compared to the priority assigned to the first time period when the first task is carried out the first time.

In the solution discussed above, a method for requesting the resource needs for a robotic device in a cellular network is proposed. The cell in which the robotic device is located may have at least one robotic device connected to a control device such as the controller application shown in FIG. 1 via a wireless connection. As discussed above, the duration of the actions of the robotic device is determined for each of the different actions and a time period is calculated how long the action will take. Furthermore, the quality of service requirements are considered and the radio resources of the wireless connection of the robotic device. Additionally, the radio resources are requested or reserved for the duration of the corresponding actions carried out by the robotic device. Furthermore, it is possible to receive a feedback on the success of the request and if needed it is possible to adjust the action plan for the robotic device accordingly.

The solution discussed above provides an improved productivity of the robotic device provided in a cellular network as the required radio resources are guaranteed to be available throughout the whole operation resulting in an improved control of the robotic device.

1. A method for operating a resource reservation entity configured to reserve radio resources in a cellular network for a plurality of user entities connected to the cellular network, the plurality of user entities comprising at least one first user entity connected to a robotic device which is controlled by control commands transmitted through the cellular network to the first user entity, and at least one second user entity not connected to any robotic device, the method comprising at the resource reservation entity:
receiving a first message indicating future resource needs as needed by the at least one first user entity to control at least one first task to be carried out by the robotic device based on the control commands, the resource needs including a first time period defined by a defined starting time of the at least one first task and a duration of the at least one first task; and
reserving the radio resources for the plurality of user entities, wherein in the reserving, a priority assigned to the at least one first user entity is increased for the duration of the first time period relative to the priority assigned to the at least one second user entity, and the priority assigned to the at least one first user entity in the first time period is higher than the priority assigned to the at least one second user entity.

2. The method according to claim 1, wherein the priority assigned to the at least one first user entity is decreased again relative to the priority assigned to the at least one second user entity after the first time period is over.

3. The method according to claim 1, wherein the future resource needs include a traffic pattern for the radio resources during the first time period, wherein the radio resources are reserved during the first time period taking into account the traffic pattern.

4. The method according to claim 1, wherein a timer is activated at the defined starting time which expires when the first time period is over, wherein the priority assigned to the at least one first user entity is controlled based on the activation of the timer.

5. The method according to claim 1, wherein reserving the radio resources comprises using a weight based reserving, in which a plurality of factors are weighted in order to reserve the radio resources for the plurality of user entities, the factors comprising a first factor relating to quality of service requirements valid for the plurality of user entities, the quality of service requirements depending on the priority assigned to the plurality of user entities, a second factor describing a quality of an obtained radio channel, and a third factor describing an interference level between at least some of the plurality of user entities.

6. The method according to claim 1, wherein, for increasing the priority of the first factor in the first time period, a weight assigned to the first factor is increased by a first value for the first time period.

7. The method according to claim 6, wherein the first value is a constant value and the increase of the weight assigned to the first value is removed when the first time period is over.

8. The method according to claim 1, wherein the resource needs comprise a possible maximum delay for the control commands until when the control commands have to be arrived at the first user entity, wherein the radio resources are reserved taking into account the possible maximum delay.

9. The method according to claim 1, further transmitting a scheduling message to the at least one first user entity when the first time period is about to start, the scheduling message comprising a UE identifier allowing the at least one first user entity to be identified.

10. The method according to claim 1, wherein the future resource needs received in the first message relate to different tasks carried out by one of the at least one first user entities in a sequence of tasks, wherein different time periods are defined for the different tasks, and the priority assigned to the at least one first user entity is increased in each of the different time periods relative to the priority of the second user entity.

11. The method according to claim 10, wherein the priority assigned to each of the different time periods is not the same for all of the different time periods.

12. The method according to claim 1, wherein a device control entity configured to control the robotic device is informed when it is determined that the reserving of the radio resources in not possible in the first time period as requested by the future resource needs.

13. The method according to claim 1, wherein the at least one first task is a repeated first task carried out several times, wherein a feedback is received with an accuracy indication indicating a failed accuracy when the first task is carried out a first time of the several times, wherein the accuracy indication is taking into account when reserving the radio resources for the first task when it is carried out a second time from the several times after the first time, wherein the priority assigned to the first time period when the first task is carried out a second time is higher compared to the priority assigned to the first time period when the first task was carried out the first time.

14. A resource reservation entity configured to reserve radio resources in a cellular network for a plurality of user entities connected to the cellular network, the plurality of user entities comprising at least one first user entity connected to a robotic device which is controlled by control commands transmitted through the cellular network to the first user entity, and at least one second user entity not connected to any robotic device, the resource reservation entity comprising a memory and at least one processing unit, the memory containing instructions executable by the at least one processing unit, wherein the resource reservation entity is operative to:
receive a first message indicating future resource needs as needed by the at least one first user entity to control at least one first task to be carried out by the robotic device based on the control commands, the resource needs including a first time period defined by a defined starting time of the at least one first task and a duration of the at least one first task; and
reserve the radio resources for the plurality of user entities, wherein in the reserving, a priority assigned to the at least one first user entity is increased for the duration of the first time period relative to the priority assigned to the at least one second user entity, and the priority assigned to the at least one first user entity in the first time period is higher than the priority assigned to the at least one second user entity.

15. The resource reservation entity according to claim 14, further being operative to decrease the priority assigned to the at least one first user entity again relative to the priority assigned to the at least one second user entity after the first time period is over.

16. The resource reservation entity according to claim 14, wherein the future resource needs include a traffic pattern for the radio resources during the first time period, the resource reservation entity being operative to reserve the radio resources during the first time period taking into account the traffic pattern.

17. The resource reservation entity according to claim 14, further being operative to active a timer at the defined starting time which expires when the first time period is over, and to control the priority assigned to the at least one first user entity based on the activation of the timer.

18. The resource reservation entity according to claim 14, further being operative, for reserving the radio resource, to use a weight based reserving, in which a plurality of factors are weighted in order to reserve the radio resources for the plurality of user entities, the factors comprising a first factor relating to quality of service requirements valid for the plurality of user entities, the quality of service requirements depending on the priority assigned to the plurality of user entities, a second factor describing a quality of an obtained radio channel, and a third factor describing an interference level between at least some of the plurality of user entities.

19. The resource reservation entity according to claim 14, further being operative, for increasing the priority of the first factor in the first time period, to increase a weight assigned to the first factor by a first value for the first time period.

20. (canceled)

21. The resource reservation entity according to claim 14, further being operative, wherein the resource needs comprise a possible maximum delay for the control commands until when the control commands have to be arrived at the first user entity, wherein resource reservation entity is operative to reserve the radio resources taking into account the possible maximum delay.

22-28. (canceled)
